(19) United States
(12) Patent Application Publication
(10) Pub. No.: US 2025/0176478 A1
(43) Pub. Date: Jun. 5, 2025

(54) APPARATUS AND METHOD FOR AGRICULTURAL MECHANIZATION

(71) Applicant: Yang FANG, Pleasanton, CA (US)

(72) Inventor: Yang FANG, Pleasanton, CA (US)

(21) Appl. No.: 18/725,681

(22) PCT Filed: Dec. 29, 2022
(86) PCT No.: PCT/US2022/054273

§ 371 Date: Jul. 1, 2024

Related U.S. Application Data
(60) Provisional application No. 63/294,627, filed on Dec. 29, 2021.

(51) Int. Cl. A01G 17/02; A01D 46/30; A01M 21/02; B25J 11/00

(52) U.S. Cl. CPC A01G 17/023; A01D 46/30; A01M 21/02; B25J 11/0045

(57) ABSTRACT

Methods, devices, and systems, that relate to mechanization of agricultural tasks, including a robotic tool carrier configured to be mounted on a tractor or other type of vehicle and employing imaging and artificial intelligence to perform agricultural tasks, such as pruning, cutting vegetables, or weeding crops.

### CROSS-REFERENCE TO RELATED APPLICATIONS

This application claims priority from U.S. Provisional Application No. 63/294,627, filed on Dec. 29, 2021, the disclosure of which is incorporated herein by reference in its entirety.

### FIELD

This disclosure relates to mechanization of agricultural tasks. More specifically, the disclosure relates to a tool carrier configured to be mounted on a tractor or other type of vehicle and employing imaging and artificial intelligence to perform agricultural tasks, such as pruning crops.

### BACKGROUND

The labor force for farm laborers has been steadily decreasing since 2000. Specialty crops, including fruits, vegetables, tree nuts, and nursery crops, are some of the most labor-intensive crops to farm with labor costs being a large percentage of the overall expenses for those crops. Farmers want to mechanize tasks traditional performed by laborers, but current mechanized farm equipment does not have automatic adjustment features which leads to poor quality and crop damage.

One example of a specialty crop with tasks that farmers would like mechanize is grape vine pruning. Grape vines are pruned at least annually to prune shoots and canes that grow from the grape vine cordon, which is a long arm of the vine, usually trained to grow horizontally along a wire, from which shoots and fruiting canes develop. This pruning typically is a manual task, but with laborer shortages and the correspondingly high cost of labor expense, farmers are looking for options to prune other than by using manual labor. A hindrance to mechanizing grape vine pruning is being able to determine where the shoots and canes are to be cut and avoiding damaging the grape vine cordon. One option to support mechanization is to replant the crops so that tools that can go straight to the point where the plant is to be cut can be used. However, this is a costly option and one unlikely to be followed. What farmers want is an automated pruning tool that follows the grape vine's shape without damaging the grape vine cordon which can be used in existing vineyards.

Another example where agricultural mechanization is desired is weeding in a tree nursery. Today, weeding often is done manually using hands and shovels. Farmers would like a mechanized solution that automatically follows the tree locations despite variations in the locations of the trees, and extracts weeds without damaging the trees.

Yet another example where agricultural mechanization is desired is with vegetable harvesting. The height of a vegetable plant varies. It has to be cut at the correct height. Taking celery as an example, if the celery plant is cut too high the celery stalks can fall apart into pieces. If it is cut too low, too much soil comes with the cut vegetable and can be included with the vegetable in the vegetable packaging. Farmers would like a mechanized solution that automatically adjusts the cutting height for the vegetable despite variations in the appropriate cutting height for each vegetable.

What is needed is a mechanized solution that automatically determines the locations of plants that are to be avoided to prevent damage, while locating the points on those plants to be pruned or the weeds to be extracted.

### SUMMARY

Some embodiments of the present disclosure solve the previously mentioned problems and other problems of the background art. However, not all embodiments of the present disclosure are required to solve those problems to practice the inventive techniques of the present application.

Some embodiments of the present disclosure enable a tool carrier apparatus, that includes a tool for working on a plant planted in the ground; an adjustable carrier configured to hold the tool and move the tool in a horizontal direction and a vertical direction with respect to the ground and configured to mount to a vehicle; a camera configured to capture an image of a plant, the plant having a protected portion; a memory having a program stored therein; a processor that when executing the program implements: an artificial intelligence engine trained to identify the protected portion of the plant, receive the captured image of the plant, and output an indication of the protected portion of the plant; and a control algorithm outputting a control command based on the output from the artificial intelligence engine; a robotic controller configured to control the adjustable carrier based on the control command to position the tool to work on the plant while avoiding contacting the protected portion of the plant.

In some embodiments of the present disclosure the camera is mounted on the adjustable carrier.

In some embodiments of the present disclosure the tool is a cutting tool to work on the plant by cutting a portion of the plant.

In some embodiments of the present disclosure the plant is a grape vine and the protected portion of the plant is a cordon of the grape vine.

In some embodiments of the present disclosure the adjustable carrier comprises an adjustable horizontal arm moveable in the horizontal direction, an adjustable vertical arm moveable in the vertical direction with respect to the ground, and an end effector attached to one of the adjustable horizontal arm and the adjustable vertical arm and configured to hold the tool.

In some embodiments of the present disclosure the camera is attached to the end effector by a rigid support and in close proximity to the tool.

In some embodiments of the present disclosure the plant is a vegetable and the artificial intelligence engine is trained to identify the protected portion of the plant so that the robotic controller causes the position of the cutting tool to correspond to a predicted portion of the vegetable between a lower point of the vegetable and an upper point of the vegetable.

In some embodiments of the present disclosure the lower point of the vegetable corresponds to a point where soil is not taken when the vegetable is cut and the upper point of the vegetable corresponds to a point where the cut vegetable is not likely to divide into separate pieces.

In some embodiments of the present disclosure the plant is a crop planted in one of a plurality of rows of the crop, and the tool is configured to extract a weed disposed between the rows of crops while avoiding damaging the plant.

In some embodiments of the present disclosure wherein the vehicle is a tractor.

### BRIEF DESCRIPTION OF THE DRAWINGS

Further features, the nature, and various advantages of the disclosed subject matter will be more apparent from the following detailed description with reference to the accompanying drawings in which:

FIG. 1 illustrates an overview of a sequence of steps that an artificial intelligence (AI) powered vehicle, according to one embodiment, such as a tractor, goes through to perform an agricultural task such as automatically pruning a grape vine.

FIGS. 2A and 2B illustrate the location of a part of a plant, in this case a cordon of a grape vine, predicted by an AI model, from images captured by an imaging system. The figure shows an AI mask output of the predicted location of the cordon superimposed over an image of the grape vine cordon. The figure also shows the path of a cutting tool controlled to follow the shape of the cordon, but a distance away from the cordon to prevent cutting or otherwise damaging the cordon.

FIG. 3 is a flow diagram illustrating interactions between various elements that operate on images input from a camera and that output control signals to control an adjustable tool carrier and tool.

FIG. 4 illustrates an example embodiment of an AI powered tool carrier system mounted on a tractor.

FIG. 5A illustrates an example embodiment of an adjustable tool carrier and tool with the tool carrier adjusted in a width and height direction to place the tool in a first location.

FIG. 5B illustrates an example embodiment of the adjustable tool carrier and tool with the tool carrier adjusted in the width and height direction to place the tool in a second location.

FIG. 6A illustrates an example embodiment of the AI powered tool carrier system mounted on a tractor with the tractor tilted at an angle due to variations in the level of the ground.

FIG. 6B illustrates an example embodiment of the AI powered tool carrier system mounted on a tractor with the plant to be cut tilted at an angle with respect to the level of the ground.

FIG. 6C illustrates a raw image that is blurry as result of the camera being mounted on the carrier and the carrier vibrating.

FIG. 6D illustrates the raw image shown in FIG. 6C with the predicted location of the cordon superimposed on the raw image.

FIG. 6E illustrates a raw image with motion blurs as result of the camera not being able to find focus on the part of the grape vine where the cordon is located.

FIG. 6F illustrates the raw image shown in FIG. 6E with the predicted location of the cordon superimposed on the raw image.

FIG. 7A illustrates a retraction sensor in a first position prior to sensing an object.

FIG. 7B illustrates the retraction sensor in a second position when sensing an object.

FIG. 8 is a diagram illustrating a hardware configuration of an information processing system that can be used to implement various devices of at least some embodiments of the invention.

### DETAILED DESCRIPTION

Illustrative embodiments of the invention will now be described in detail with reference to the attached drawings in which like reference numerals refer to like elements.

In certain embodiments of the invention, a robotic tool carrier system is mounted to a tractor for mobile operation of a tool. The robotic tool carrier system includes an adjustable tool carrier with the tool attached to the carrier. In an embodiment, the adjustable tool carrier includes horizontal and vertical positioning arms with cylinders to adjust the lengths of the horizontal and vertical arms. These horizontal and vertical arms can adjust the location of the tool in horizontal and vertical directions with respect to the ground. In one embodiment the tool is disposed at one end of the horizontal arm. In another embodiment the tool is disposed at one end of the vertical arm. In yet another embodiment the adjustable tool carrier is disposed at one end of an articulable robotic arm controllable to move in at least two dimensions: vertically and horizontally with respect to the ground level, with the horizontal movement being orthogonal to the direction of the motion of the vehicle, such as a tractor, to which the robotic tool carrier system is mounted.

A camera, such as a stereo camera, is mounted to the adjustable tool carrier in close proximity to the tool to capture real-time images of the crop to be operated on by the tool. In certain embodiments the camera is attached to a support that is rigidly attached to the tool so that the camera moves with the tool. Images from the camera are input into a computing device, which includes, in addition to one or more processors and memories, a deep learning prediction model. The model uses the images to predict a characteristic about the crop.

In the case of a vineyard pruning application, the camera captures in real-time images of the grape vine and the model, having been trained to recognize the cordon of a grape vine, predicts the location of the cordon from the captured images. The captured images can be from a video stream output from the camera. This prediction is used as input to a robotic controller that controls the horizontal and vertical positioning arms, or the articulable robotic arm, to adjust the position of a cutting tool disposed on one of the horizontal or vertical positioning arms, to prune canes and shoots growing out of a cordon while avoiding cutting or otherwise damaging the cordon.

### Operational Concept

In operation, the cutting tool can be attached to the robotically controlled positioning arm(s) to move the cutting tool both vertically and horizontally. The stereo camera, attached to the tractor, acquires real-time images of the crop being pruned or trimmed. When pruning or trimming a grape vine, the camera captures images of the grape vine growing on a trellis. The grape vine has a cordon, which generally is a horizontally disposed part of the vine from which canes and shoots grow. Every year the canes and shoots are pruned to promote proper growth of the vine. When this pruning occurs, the cordon must be protected from being cut or otherwise damaged.

Some embodiments of robotic tool carrier system use imaging and artificial intelligence with a deep learning prediction model to predict the location of the cordon and control the robotic arm to position the cutting tool to perform the pruning while avoiding the cordon. The robotic arm can be controlled to adjust the cutting tool in the vertical direction to raise or lower the cutting tool to essentially follow the shape of the cordon that is detected by the camera and AI engine. The robotic arm also can be controlled to adjust the cutting tool in the horizontal direction to move the cutting tool into and out of the row where the vine is planted to reach the shoots and canes to be pruned or to move the cutting tool to avoid an object such as a vertical trellis support pole.

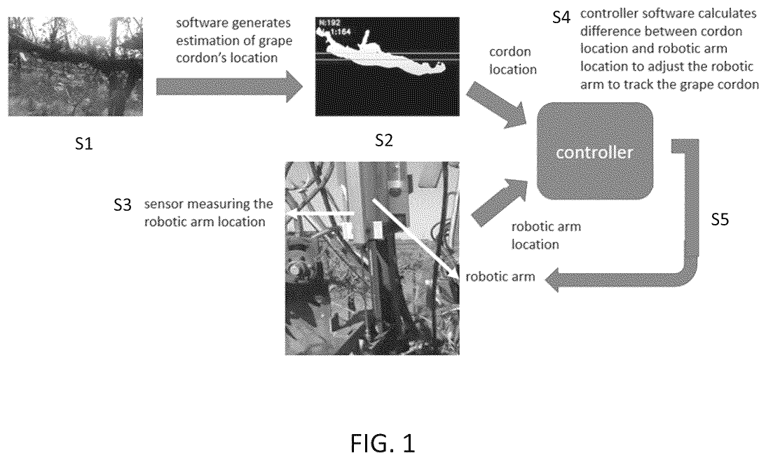

FIG. 1 illustrates an example operational flow of an embodiment of a robotic tool carrier system. In a first step S1, the camera captures images of a crop, typically growing in rows, as the tractor moves along a row of the crop, in this case a grape vine. In a second step, S2, the deep learning prediction model, in an AI engine, predicts the location of the grape vine cordon based on the input images and provides that predicted cordon location to a robotic controller. In step S3 sensors measure the location of the robotic arm and provide those measurements to the robotic controller. Software in the robotic controller calculates, at step S4, the difference between the predicted cordon location and the measured location of the robotic arm. The difference information is used to generate a control signal that controls the robotic arm, in step S5, to adjust the position of the robotic arm to place the cutting tool at a target location on the grape vine to prune portions of the vine while avoiding cutting or otherwise damaging the cordon. In this way, the robotic arm can be controlled to adjust the cutting tool in the vertical direction to raise or lower the cutting tool to essentially follow the shape of the cordon that is detected by the camera and AI engine, to prune the grape vine's canes and shoots at a specific distance from the cordon.

Using computer vision to track crop variations in real time, as with this method, to control the position of the robotic tool carrier to automatically rise and fall to follow the shape of the cordon avoids cutting or otherwise damaging the cordon as the tractor moves along a row of grape vines. This AI powered robotic tool carrier, reduces damage to the crop, while maintaining human level quality and consistency of the pruning operation, significantly saving labor costs. By using the deep learning AI model to learn the farm structure, farmers do not need to change the structure of the farm to get the benefits of an automated mechanized pruning or cutting tool.

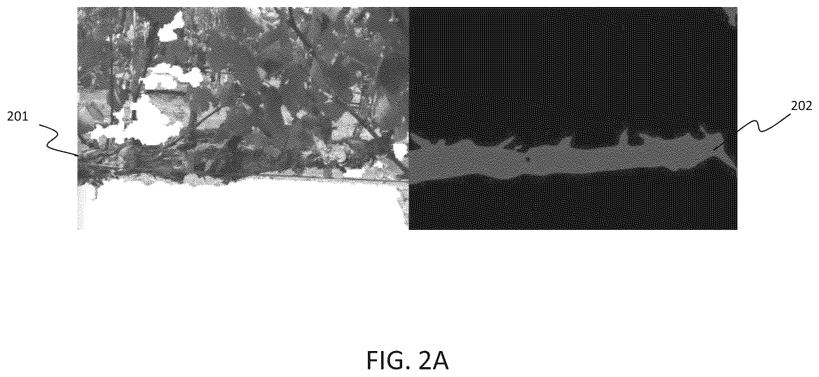

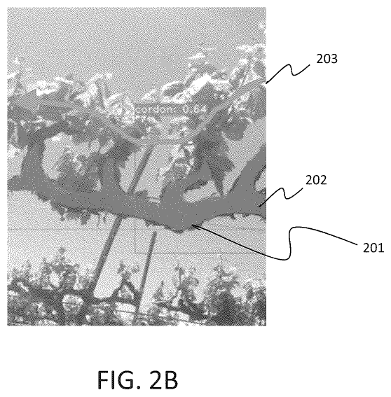

FIG. 2A shows, on the left hand side of the figure, an example of a raw image taken by a camera mounted on an embodiment of the robotic tool carrier. The cordon 201 is difficult to see in the image due to leaves and branches obscuring the cordon. The right hand side of the figure shows a visualization of an AI mask output from the AI model clearly showing the predicted location of the cordon 202. The robotic controller controls the position of the robotic arm and tool based on the AI mask output of the cordon to make a cut at the appropriate location on the vine while missing the cordon. FIG. 2B shows a raw image of a grape vine with a cordon 201 and an AI mask output 202 illustrating the predicted location of the cordon superimposed over the raw image. Based on the predicted location of the cordon, the cutting tool can be positioned at a location 203 that follows the shape of the cordon. In some embodiments the location of the cutting tool is set to be placed a predetermined distance above or below the cordon.

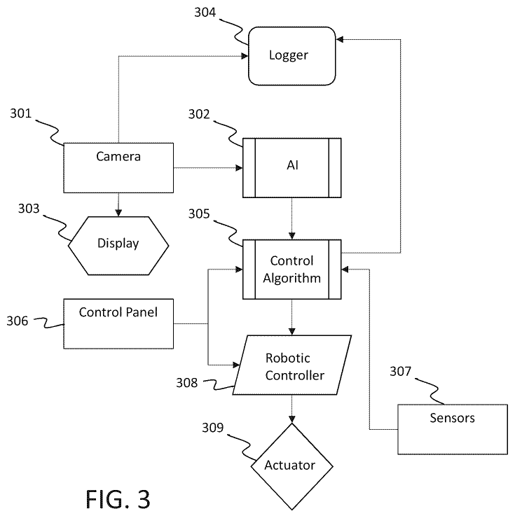

A system diagram of an embodiment of a robotic tool carrier system is illustrated in FIG. 3. The system includes a camera 301 coupled to an AI engine implementing a deep learning prediction model 302. The camera also is coupled to a display 303 to display configuration, control, and performance information, and to a logger 304 for logging information captured by the camera. Based on the images captured by the camera, the AI predication model 302 outputs an AI mask indicating the predicted location of the cordon. This output is provided to a control algorithm 305 which also receives inputs from sensors 307, which can be sensors on the robotic tool carrier system, sensors on the tractor, or other external sensors. The control algorithm 305 compares the predicted location of the cordon from the output AI mask with the information input from the sensors 307 to determine the difference between the sensed location of the robotic arm and the predicted location of the cordon. The control algorithm also can receive signals from a control panel 306 to configure and monitor the control algorithm. The control algorithm generates control information based on this difference and outputs the control information to a robotic controller 308. The robotic controller receives configuration information and signals from control panel 306 and generates control signals based on the control information from the control algorithm 305 as well as the configuration information from the control panel 306. The robotic controller outputs the generated control signals to actuators 309 which operate to position or move the tool carrier's robotic arm(s). The AI engine implementing the deep learning prediction model 302 and the control algorithm can be implemented by software executing on the same or different computer processors.

### Robotic Tool Carrier System

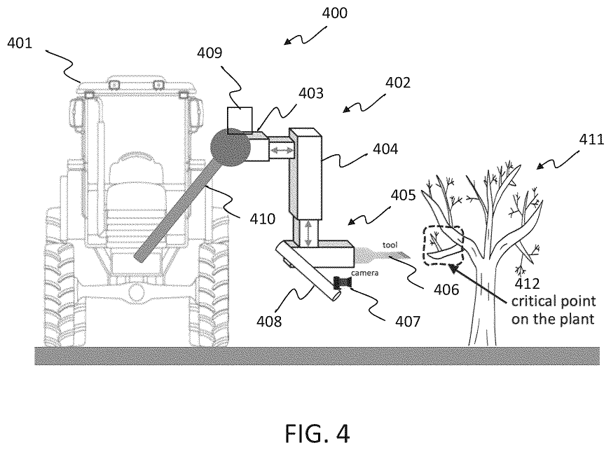

An embodiment of an AI powered robotic tool carrier system 400 is illustrated in FIG. 4. In this embodiment a tractor 401 is an example of a vehicle on which a tool carrier 402 is mounted. In this embodiment the tool carrier 402 includes a horizontal positioning cylinder 403 and a vertical positioning cylinder 404. These positioning cylinders can be hydraulic cylinders, the length of which is adjustable by applying a control signal. In this embodiment, one end of the horizontal positioning cylinder 403 is attached or mounted to the tractor 401. The other end of the horizontal positioning cylinder 403 is attached to an end of a vertical positioning cylinder. Attached to another end of the vertical positioning cylinder 404 is an end effector 405. A tool 406 is attached to an end of the end effector 405. Some embodiments can have more than one tool 406 attached to the end effector 405 so that different portions of the crop can be worked on simultaneously. An example of a tool 406 is a cutting or pruning tool suitable for cutting a grape vine or portions of a grape vine such as canes and shoots. The cutting or pruning tool can have a single cutting portion or multiple cutting portions that can makes cuts along a length of the cutting tool like a hedge trimmer. For example the cutting tool can have a cutting length of two to three feet. A camera 407 is attached to the tool carrier 402 in an eye-in-hand robotic configuration with the tool such that the camera moves together with the tool. This configuration allows for the use of a common and coarse mechanical platform that achieves good accuracy, is simple to maintain, and does not need calibration. The camera 407 is mounted on a camera support 408 that is rigidly attached to the end effector 405 and in close proximity to the tool 406 so that the image obtained from the camera is a close representation of the view that would been seen from the vantage point of the tool 406.

A controller 409 receives the output of the control algorithm and generates signals to control actuators that drive the end effector and operate the tool 406. The controller 409 may be mounted on the robotic tool carrier system or may be mounted on the tractor 401. Some embodiments of the controller 409, and the software configured to execute on the controller, include the AI model 302, the control algorithm 305, and the robotic controller 308, shown in FIG. 3. In other embodiments, the AI model 302, the control algorithm 305, and the robotic controller 308 can be configured to execute on separate controller devices. In some embodiments the controller communicates with other components of the robotic tool carrier system by wired connections and in other embodiments through wireless connections.

The AI powered robotic tool carrier system 400 is attached to a vehicle, such as tractor 401, with an attachment structure 410. In some embodiments, an AI powered robotic tool carrier system 400 can be attached, with separate attachment structures 410, to each side of the vehicle allowing two rows of crops to be worked on by the tool carriers simultaneously as the tractor drives between the rows.

The tool 406 is controlled to operate on a specific location on a target plant 411. This specific location of the plant is referred to here as the critical point on the plant. To keep good quality and reduce damage to the plant from mechanization, the camera is integrated with the end effector. The relative position of the tool with respect to the Cartesian coordinates of the camera is fixed. Therefore, as long as the camera 407 is positioned to look at the critical point on the plant 412, the tool 406 also will be positioned to operate on the critical point 412. The controller software constantly analyzes the camera images to adjust the horizontal (width) position and vertical (height) position of the end effector to make camera look at the same critical point on the plant. Accordingly, the tool will be positioned to work on the critical point.

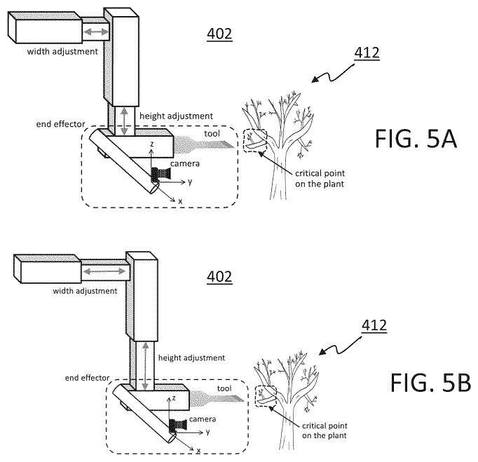

FIGS. 5A and 5B show the tool carrier 402 in two different states. The first state is shown in FIG. 5A in which the width adjustment of the horizontal positioning cylinder 403 is made relatively small and the height adjustment of the vertical positioning cylinder 404 also is made relatively small causing the tool to be pulled away from the plant and raised relatively high. The second state is shown in FIG. 5B in which the width adjustment of the horizontal positioning cylinder 403 is made relatively large and the height adjustment of the vertical positioning cylinder 404 also is made relatively large causing the tool to be extended toward the plant and lowered relatively low. These width and height adjustments are controlled by controller 409 based on the predicted positon of the cordon and the measured position of the tool.

By controlling the height and width position of the tool, the robotic tool carrier system can quickly adjust for and accommodate movements by the tractor, up, down, and sideways, to keep the tool properly aligned with the critical point on the plant to work on the plant. In the case of pruning grape vines, this rapid and automatic changing of the tool' position allows the grape vine's canes and shoots to be pruned at the appropriate position while keeping the cutting tool away from the cordon, thereby preventing damage to the cordon.

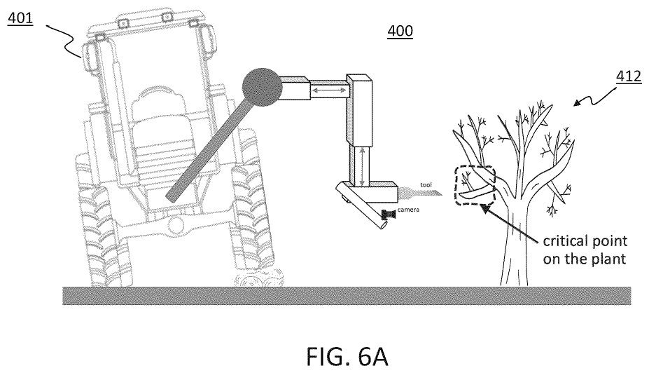

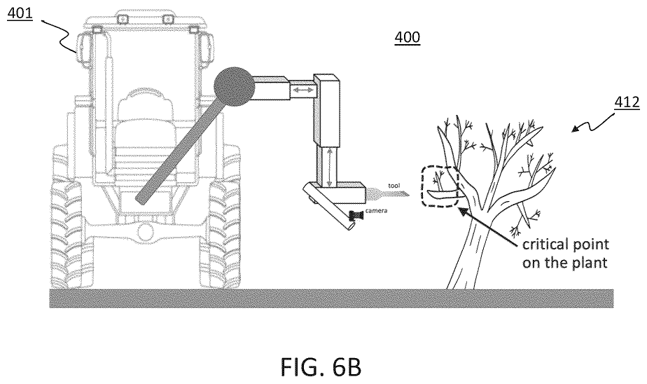

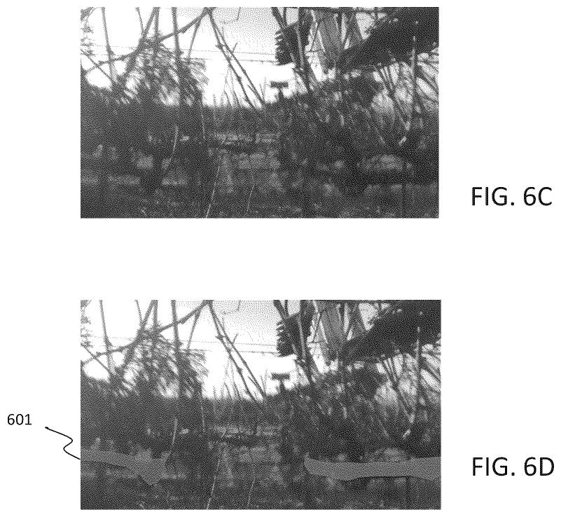

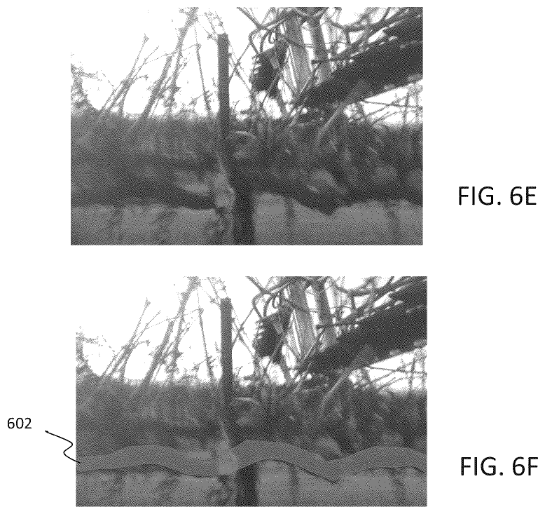

As the tractor moves on uneven surfaces, uphill and downhill. The camera based adjustment keeps the tool positioned at the critical point on the plant. FIG. 6A illustrates a state in which the tractor 401 tilts as a result of the tractor's tire running over a bump in the ground. The posture of the tractor also could change if one of its wheels goes into a depression in the ground. In either case, the imaging system in combination with the AI prediction model will cause the controller 409 to adjust the width and height of the horizontal and vertical positioning cylinders 403 and 404 to position the cutting tool at the critical point on the plant, in this case a predetermined distance from the cordon, thereby compensating for any tilt of the tractor.

FIG. 6B illustrates a state in which the plant is tilted so that it is not orthogonal to the ground. Not all plants grow perfectly vertically. To accommodate a plant that grows at an acute or obtuse angle with respect to the ground, the imaging system in combination with the AI prediction model will cause the controller 409 to adjust the width and height of the horizontal and vertical positioning cylinders 403 and 404 to position the cutting tool at the critical point on the plant, which in this case is a predetermined distance from the cordon, thereby compensating for a plant that is not growing at a right angle with respect to the ground.

This robotic tool carrier system also will accommodate the tool working on plants of different heights, as the camera based adjustment keeps the tool working on the critical point on the plant.

In some embodiments the positions of the horizontal and vertical positioning cylinders can be reversed with the end effector attached to the horizontal positioning cylinder and the vertical positioning cylinder attached to the tractor.

In other embodiments, the tool carrier 402 can be formed from a single robotic arm with one or more articulating joints rather than from the adjustable length and width of the horizontal and vertical positioning cylinders.

Other configurations for adjusting the horizontal and vertical positons of the end effector may be used with the present robotic tool carrier system so long as the controller can control the horizontal and vertical positons of the tool.

In some embodiments sensors, such as sensors 307 shown in FIG. 3, measure parameters that can be input to the control algorithm 305. Once such sensor can be a speed sensor sensing the speed of the tractor. The speed of the tractor can be used by the control algorithm to determine how quickly or slowly the position of the tool should be adjusted. For example, if the tractor is traveling fast, the controller may need to move the tool more often and more quickly than when traveling slowly. In one embodiment the control algorithm makes adjustments in the tool position every 30 ms. For a fast traveling tractor the system might be configured to change the tool position every 30 ms, whereas for a slow traveling tractor the system might be configured to change the tool position every second.

One feature of the robotic tool carrier system is the mounting location of the camera. The robotic tool carrier system uses the camera and AI as a sensing module to locate the object. Rather than following the usual approach of positioning the camera on the tractor, in some embodiments the camera is mounted on the end effector. There are several advantages to mounting the camera on the end effector, including:
a. The sensing module is very close to the object the equipment needs to work on, therefore it has better view angle and less obstruction from other objects.
b. The relative position offset between the camera and end effector will not change, therefore there is no need for calibration. Calibration is a large burden in farming applications. Since the application environment is very abusive, equipment is under constant service and modification. Because of this harsh environment it is beneficial to have a system that does not require calibration, or require it often.

While there are advantages to mounting the camera on the end effector this also creates some problems. One problem with this mounting location is that the camera experiences much movement and vibration causing blurs and fuzzy images. Because these tools are constantly moving, and moving parts on the tool can generate large vibration, it is very difficult to use traditional image processing to reliably work on these images. Some embodiments of the present disclosure use a deep learning neural network method to predict the location of a crop or a portion of a crop from input images. A large number of blurry images were collected when the camera was mounted on the tool. These blurry images were used as data to train an AI model that can work reliably with low quality images.

FIG. 6C shows an example raw image captured by the camera that is blurry with significant distortion resulting for the camera moving and vibrating while the tractor drives along a row and the tool pruning the grape vine's shoots and canes. The deep neural network, after being trained on many such images, detects the desired object, in this case the grape vine's cordon. FIG. 6D shows the blurry image with the output of the AI engine implementing the deep learning prediction model 302 superimposed on the image and showing the predicted location of the cordon 601.

FIG. 6E shows an example raw image captured by the camera that has motion blurs as a result of the camera not being able to find focus on the portion of the vine where the cordon is located. The deep neural network, after being trained on many such images, detects the desired object, in this case the grape vine's cordon. FIG. 6F shows the image with motion blurs with the output of the AI engine implementing the deep learning prediction model 302 superimposed on the image and showing the predicted location of the cordon 602.

The camera is mounted upstream of the tool so the system can react to objects detected in the images before the tool arrives at the location of the object. For example, the camera can be mounted about 1 foot upstream of the tool and on approximately the same horizontal plane of as the tool.

### Retraction Mechanism

In agriculture applications, other than natural plants, human built objects used for supporting the natural plants also can be encountered when working on the plants. There is a need for equipment to have intelligence to avoid hitting these objects. In a vineyard, metal posts often are installed to support the trellis system on which the vines grow. When a machine operates in such an environment, it is important not to damage these human built objects. Embodiments of the robotic tool carrier system use mechanical sensors to assist the deep learning neural network to achieve this purpose of avoiding the human built supporting objects.

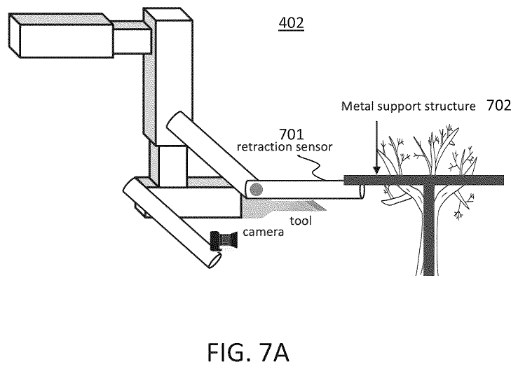

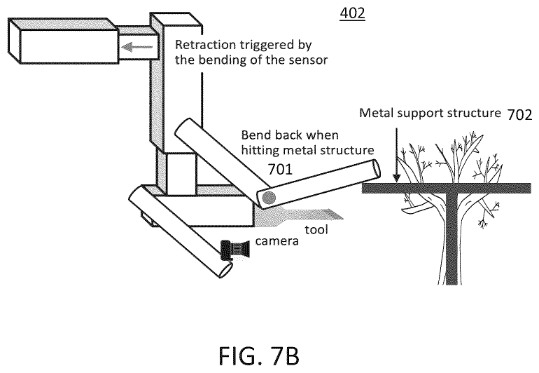

In some embodiments, a retraction mechanism, such as retraction sensor 701 shown in FIG. 7A, is used to sense a human built object and generate a control signal that moves the tool carrier out of the way of the object. In one embodiment the retraction sensor 701 includes a long rod connected, by a hinge, to a support attached to the tool carrier 402. The retraction sensor 701 is positioned so the long rod is disposed at or beyond a leading edge of the tool carrier 402. The retraction sensor 701 is configured so the long rod contacts the human made object before any other part of the tool carrier 402 can contact the object while the tractor is proceeding down the row of crops. FIG. 7A shows the retraction sensor 701 with the long rod in an initial position prior to contacting an object other than the crop. Upon contact the retraction sensor 701 is configured to easily bend back at the hinge as shown in FIG. 7B, triggering a sensor that generates a retraction signal indicating that the long rod has come into contact with a rigid object. The retraction signal is transmitted to the controller 409 trigging a response that retracts the tool carrier 402 to avoid the tool 406 from coming into contact with the human made object. The retraction sensor includes a spring that operates to pull the long rod back into its initial position after the long rod passes the object.

In the example of a metal post 702 in a grape vine trellis, before the long rod of the retraction sensor 701 hits the metal post, the horizontal positioning cylinder 403 is extended in its working condition. When the long rod hits the metal post 702 it bends or deflects backward at the hinge causing a signal to be transmitted to the controller 409 indicating that an object has been sensed. This in turn causes the controller to shorten the length of the horizontal positioning cylinder retracting the tool away from the row of crops and preventing the tool, such as a cutter, from contacting and possibly cutting the metal post 702.

This sensing also can be used to trigger a data collection system and record images of the metal post. This data can be used to train a deep learning neural network to be able to detect the metal post. Once trained, the system can detect the human made objects from the images and retract the tool without having to rely on a mechanical retraction rod. These two sensing mechanisms also can be combined to reduce false triggers and make the system work reliably.

### Hardware/Software Environment

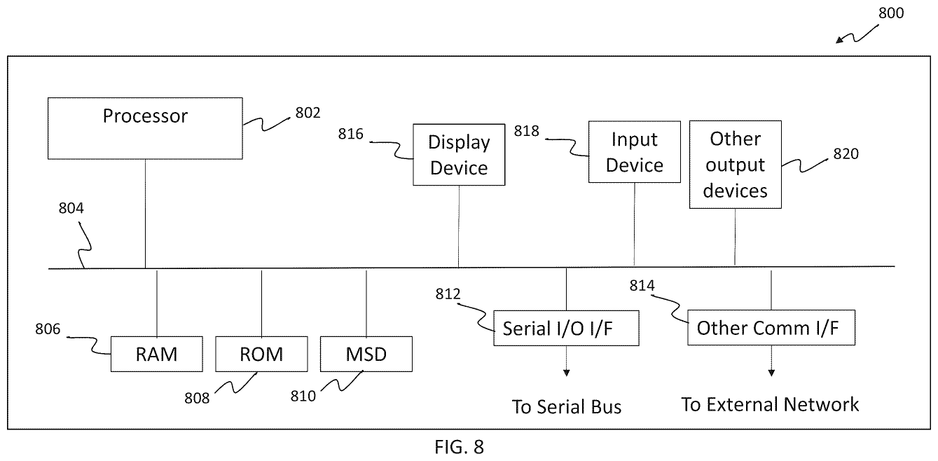

A hardware configuration of an information processing system 800 according to one exemplary embodiment is shown in FIG. 8. This embodiment can be used to implement, for example, the controller 409, and other computer implemented structures disclosed herein. While the information processing system 800 shown in FIG. 8 illustrates various components, not all components are necessary to use in various embodiments of the computing structures described herein.

FIG. 8 is a block diagram illustrating a hardware configuration of an information processing system 800 according to an example embodiment. The AI powered robotic tool carrier system 400 can be structured, in certain embodiments, with one or more of the components of the information processing system 800 shown in FIG. 8. For example, the AI engine implementing a deep learning prediction model 302 can be structured, in certain embodiments, with one or more of the components of the information processing system 800. Similarly, the control algorithm and the robotic controller 308 can be implemented with one or more of the components of the information processing system 800. Further, the information processing system 800 has a function of a computer. For example, the information processing system 800 may be configured integrally within an embedded controller, and in other embodiments it may be configured with a general purpose computer such as a personal computer (PC), a laptop PC, a tablet PC, a smartphone, or the like.

The information processing system 800 has a processor 802, a random access memory (RAM) 806, a read only memory (ROM) 808, and a possibly a mass storage device (MSD) 810 such as a hard disk drive (HDD), an optical disk drive, an electrically erasable ROM (EEROM) or other semiconductor memory, or another known device for persistently storing large quantities of data in order to perform storage and retrieval of electronic data. Further, the information processing system 800 can include a serial input/output (I/O) interface (I/F) 812 for connection to a serial bus. In certain embodiments the information processing system 800 can include communication interfaces 814 for communications protocols other than serial data communication. In certain embodiments the information processing system 800 can include a display device 816, an input device 818, and other output devices 820. The processor 802, the RAM 806, the ROM 808, the MSD 810, the serial I/O communication I/F 814, the other communication interfaces 814, the display device 816, the input device 818, and the other output devices 820 are connected to each other via a bus 804. According to an example embodiment, the display device 816, the input device 818, the other output devices 820 may be connected to the bus 804 via a drive device (not illustrated) used for driving these devices. According to an example embodiment, the processor 802 may be a central processing unit (CPU), a microcontroller, other types of controllers, or the like. Moreover, in some embodiments the processor 802 may be comprised of one or more processors, such as a plurality of CPUs or microcontrollers. According to another example embodiment, the processor 802 may be a hardware processor. According to another example embodiment, the processor 802 may be implemented by a combination of hardware, software, and/or firmware components. According to another example embodiment, the processor 802 may be implemented by a configuration of electronic components including one or more circuitry components.

While respective components forming the information processing system 800 are illustrated in FIG. 8 as an integrated device, some of the components and/or some of the functions performed by the components thereof may be performed by an externally attached device. For example, the display device 816, the input device 818, and the other output devices 820 may be externally attached devices that are separate from apart from the components performing the functions of a computer including the processor 802 or the like.

The processor 802 has a function of performing an operation in accordance with a program stored in the ROM 808, the MSD 810, or the like, and controlling each component of the information processing system 800. According to an example embodiment, the processor 802 may obtain one or more instructions stored in the ROM 808, the MSD 810, or the like and execute the one or more instructions to perform one or more operations. The one or more operations may include controlling one or more components of the information processing system 800 to perform one or more operations. The RAM 806 is formed of a volatile storage medium and provides a temporary memory field used in the operation of the processor 802. The ROM 808 is formed of a nonvolatile storage medium and stores information such as a program used in the operation of the information processing system 800. The MSD 810 is a storage device that is formed of a nonvolatile storage medium and stores electronic data, such as message captured by the message collection device 106, or the like.

The other communication I/F 814 may be a communication interface based on a specification such as an 802.11 wireless communication standard, a 3GPP standard for cellular communication, or the like, which is a module for communicating with other devices. The display device 816 may be a liquid crystal display, an organic light emitting diode (OLED) display, or any other computer controlled device capable of displaying a moving image, a static image, a text, or the like. Examples of the input device 818 are a button, a touchscreen, a keyboard, a pointing device, or the like and capable of use by a user to operate the information processing system 800. The display device 816 and the input device 818 may be integrally formed such as in a touchscreen.

According to an example embodiment, the hardware configuration illustrated in FIG. 8 is an example embodiment of a processing system, and components or devices, other than those illustrated in FIG. 8, may be added, or some of the components or devices shown may not be provided in certain embodiments. Further, some of the components or devices may be replaced with another component or device having a similar function. Furthermore, some of the functions may be provided by another component or device via a network, or the functions forming the example embodiment may be implemented by being distributed in a plurality of components or devices. For example, the MSD 810 may be replaced with cloud storage.

While the subject matter of the present application has been particularly shown and described with reference to illustrative embodiments thereof, it will be understood by those of ordinary skill in the art that various changes in form and details may be made therein without departing from the spirit and scope of the invention as defined by the appended claims. The illustrative embodiments should be considered in a descriptive sense only and not for purposes of limitation.

While the various embodiments described herein may contain different components and features, upon reading the specification, one skilled in the art readily will realize that such components and features in one embodiment may be incorporated into or combined with components and features of another embodiment. Also, the description of various embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents thereof

The whole or part of the example embodiments disclosed above can be described as, but not limited to, the following supplementary notes.

### Supplemental Note 1

A tool carrier apparatus, comprising:
a tool for working on a plant planted in the ground;
an adjustable carrier configured to hold the tool and move the tool in a horizontal direction and a vertical direction with respect to the ground and configured to mount to a vehicle;
a camera configured to capture an image of a plant, the plant having a protected portion;
a memory having a program stored therein;
a processor that when executing the program implements:
   an artificial intelligence engine trained to identify the protected portion of the plant, receive the captured image of the plant, and output an indication of the protected portion of the plant; and
   a control algorithm outputting a control command based on the output from the artificial intelligence engine;
a robotic controller configured to control the adjustable carrier based on the control command to position the tool to work on the plant while avoiding contacting the protected portion of the plant.

### Supplemental Note 2

The tool carrier apparatus according to supplemental note 1, wherein the camera is mounted on the adjustable carrier.

### Supplemental Note 3

The tool carrier apparatus according to supplemental note 2, wherein the tool is a cutting tool to work on the plant by cutting a portion of the plant.

### Supplemental Note 4

The tool carrier apparatus according to supplemental note 3, wherein the plant is a grape vine and the protected portion of the plant is a cordon of the grape vine.

### Supplemental Note 5

The tool carrier apparatus according to supplemental note 3, wherein the adjustable carrier comprises an adjustable horizontal arm moveable in the horizontal direction, an adjustable vertical arm moveable in the vertical direction with respect to the ground, and an end effector attached to one of the adjustable horizontal arm and the adjustable vertical arm and configured to hold the tool.

### Supplemental Note 6

The tool carrier apparatus according to supplemental note 5, wherein the camera is attached to the end effector by a rigid support and in close proximity to the tool.

### Supplemental Note 7

The tool carrier apparatus according to supplemental note 6, wherein the plant is a grape vine and the protected portion of the plant is a cordon of the grape vine.

### Supplemental Note 8

The tool carrier apparatus according to supplemental note 3, wherein the plant is a vegetable and the artificial intelligence engine is trained to identify the protected portion of the plant so that the robotic controller causes the position of the cutting tool to correspond to a predicted portion of the vegetable between a lower point of the vegetable and an upper point of the vegetable.

### Supplemental Note 9

The tool carrier apparatus according to supplemental note 8, wherein the lower point of the vegetable corresponds to a point where soil is not taken when the vegetable is cut and the upper point of the vegetable corresponds to a point where the cut vegetable is not likely to divide into separate pieces.

### Supplemental Note 10

The tool carrier apparatus according to supplemental note 2, wherein the plant is a crop planted in one of a plurality of rows of the crop, and the tool is configured to extract a weed disposed between the rows of crops while avoiding damaging the plant.

### Supplemental Note 11

The tool carrier apparatus according to supplemental note 2, wherein the vehicle is a tractor.

The foregoing disclosure provides illustration and description, but is not intended to be exhaustive or to limit the implementations to the forms explicitly described. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of embodiments of the present disclosure.

Even though combinations of features are recited in the claims and/or disclosed in the specification, these combinations are not intended to limit the disclosure of possible implementations. Many of the described features may be combined in ways not explicitly recited in the claims and/or explicitly described in the above disclosure. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “including” or the like are intended to be open-ended terms. Further, the phrase “based on” is intended to mean “based, at least in part, on” unless explicitly stated otherwise. The term “or” as used herein is an inclusive “or”, and has a meaning equivalent to “and/or.”

What is claimed is:

1. A tool carrier apparatus, comprising:
a tool for working on a plant planted in the ground;
an adjustable carrier configured to hold the tool and move the tool in a horizontal direction and a vertical direction with respect to the ground and configured to mount to a vehicle;
a camera configured to capture an image of a plant, the plant having a protected portion;
a memory having a program stored therein;
a processor that when executing the program implements:
an artificial intelligence engine trained to identify the protected portion of the plant, receive the captured image of the plant, and output an indication of the protected portion of the plant; and
a control algorithm outputting a control command based on the output from the artificial intelligence engine;
a robotic controller configured to control the adjustable carrier based on the control command to position the tool to work on the plant while avoiding contacting the protected portion of the plant.

2. The tool carrier apparatus according to claim 1, wherein the camera is mounted on the adjustable carrier.

3. The tool carrier apparatus according to claim 2, wherein the tool is a cutting tool to work on the plant by cutting a portion of the plant.

4. The tool carrier apparatus according to claim 3, wherein the plant is a grape vine and the protected portion of the plant is a cordon of the grape vine.

5. The tool carrier apparatus according to claim 3, wherein the adjustable carrier comprises an adjustable horizontal arm moveable in the horizontal direction, an adjustable vertical arm moveable in the vertical direction with respect to the ground, and an end effector attached to one of the adjustable horizontal arm and the adjustable vertical arm and configured to hold the tool.

6. The tool carrier apparatus according to claim 5, wherein the camera is attached to the end effector by a rigid support and in close proximity to the tool.

7. The tool carrier apparatus according to claim 6, wherein the plant is a grape vine and the protected portion of the plant is a cordon of the grape vine.

8. The tool carrier apparatus according to claim 3, wherein the plant is a vegetable and the artificial intelligence engine is trained to identify the protected portion of the plant so that the robotic controller causes the position of the cutting tool to correspond to a predicted portion of the vegetable between a lower point of the vegetable and an upper point of the vegetable.

9. The tool carrier apparatus according to claim 8, wherein the lower point of the vegetable corresponds to a point where soil is not taken when the vegetable is cut and the upper point of the vegetable corresponds to a point where the cut vegetable is not likely to divide into separate pieces.

10. The tool carrier apparatus according to claim 2, wherein the plant is a crop planted in one of a plurality of rows of the crop, and the tool is configured to extract a weed disposed between the rows of crops while avoiding damaging the plant.

11. The tool carrier apparatus according to claim 2, wherein the vehicle is a tractor.
